(19) United States
(12) Patent Application Publication
(10) Pub. No.: US 2007/0016844 A1
(43) Pub. Date: Jan. 18, 2007

(54) Document management system, document management method and document management program

(75) Inventors: Noriyuki Komamura, Mishima-shi (JP); Kazuaki Kidokoro, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/182,405

(22) Filed: Jul. 15, 2005

(51) Int. Cl. G06F 17/00

(52) U.S. Cl. 715/500

(57) ABSTRACT

The present invention provides a technique that can retrieve the locality of documents based on a retrieval key even though electronic data of the documents to be managed do not exist, or some items of information (tag, bar-code, etc.) are not appended to the documents themselves. The present invention provides a document management system that manages information concerning the locality of documents such that the information can be retrieved based on related information which is related to the documents to be managed, the system including a related information take-in unit that takes in the related information, a locality information take-in unit that takes in locality information concerning the locality of a document whose information is taken in by the related information take-in unit, and a correspondence making unit that makes related information taken in by the related information take-in unit and locality information taken in by the locality information take-in unit correspond to each other.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention relates to a technique that manages information concerning the locality of documents such that the information can be retrieved based on related information which is related to the documents to be managed.

2. Description of the Related Art

Up to now, as a document management system that can retrieve the locality of documents where the documents are managed, there is known one configuration in which electronic data, tag information, bar-code information, etc. corresponding to paper documents to be managed and information concerning the locality of the documents are made to correspond to each other in advance to be registered in a database, and the electronic data, tag information, bar-code information, etc. are retrieved based on a retrieval key (information and condition specified for a retrieval system to find out a desired document), thereby taking in information concerning the locality of the documents.

In the above-described conventional technique, there is raised a problem that, in case the locality of a paper document that underwent image scanning alone using a scanner or a paper document that is printed out in the past and whose electronic data is deleted is wanted to be known, since corresponding electronic data, tag information, bar-code information, etc. do not exist, the locality of the paper document cannot retrieved.

It is therefore an object of the present invention to overcome the above-mentioned drawbacks by providing a technique that can retrieve the locality of documents based on a retrieval key even though electronic data of the documents to be managed do not exist, or some items of information (tag, bar-code, etc.) are not appended to the documents themselves.

### DESCRIPTION OF THE DRAWINGS

FIG. 1 shows a functional block diagram for explaining a document management system according to the present invention.

FIG. 2 shows a flow chart for explaining the flow of the processing in the document management system (document management method) in this embodiment.

FIG. 3 shows a diagram for explaining rule information.

FIG. 4 shows a diagram of an example of table information registered in a database 2, in which related information (related keyword) and locality information (place for custody) are made to correspond to each other.

### DETAILED DESCRIPTION OF THE INVENTION

The present invention will further be described below with reference to the accompanying drawings.

Throughout this description, the embodiments and examples shown should be considered as exemplars, rather than limitations on the apparatus, methods and programs of the present invention.

Description of Systems

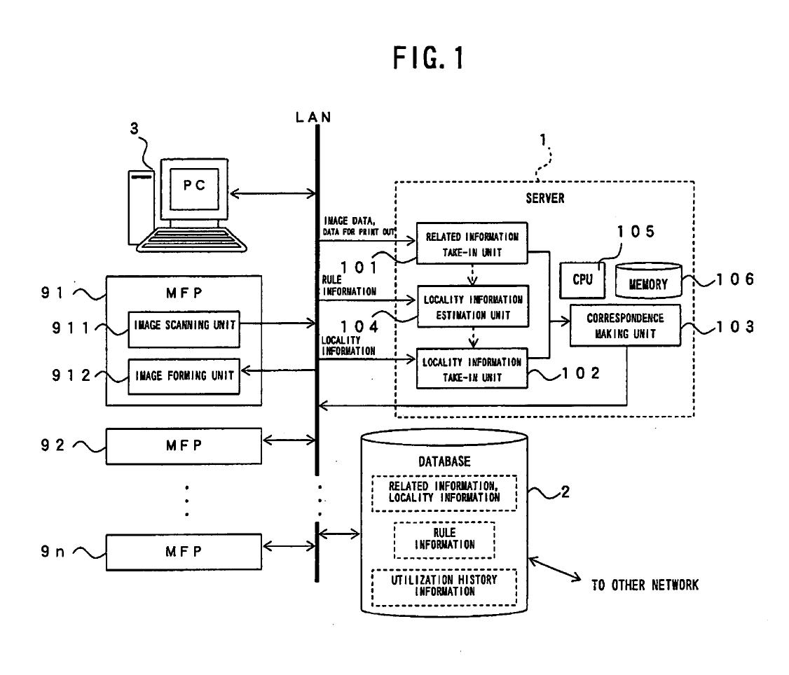

FIG. 1 shows a functional block diagram for explaining a document management system according to the present invention.

The document management system in this embodiment includes a server 1, a database 2, a PC (Personal Computer) 3, an MFP (Multi Function Peripheral) 91, an MFP 92, . . . , an MFP 9n, which are communicably connected to each other through an electric communication line such as a LAN.

The PC 3 can transmit data for print out to be formed on a sheet to the MFP 91 to MFP 9n through the server 1. Utilization history information (Log data concerning print out processing, etc.) concerning utilization history of print data, etc. about documents to be printed out at the respective MFPs is stored in the database 2.

Image data of documents whose images are scanned at the respective MFPs is not only utilized for print out processing (such as copying) at respective image forming units of the MFPs but also transmitted to the PC 3 and to the server 1.

The server 1 in this embodiment includes a related information take-in unit 101, a locality information take-in unit 102, a correspondence making unit 103, a locality information estimation unit 104, a CPU 105, and a memory 106.

The related information take-in unit 101 is provided with a function of taking in related information which is related to documents to be managed. Specifically, the related information take-in unit 101 takes in attribution information (format, composing/update date and time, file name, file path, URL, file size, etc.) such as contents information which is contents of a document, document title, document composer, document updater, document category, etc. as related information based on data for print out that is transmitted to an image forming unit (for example, an image forming unit 912 to be described later) which forms an image on a sheet so as to perform print out processing.

The related information take-in unit 101 performs predetermined image recognition processing (for example, the OCR processing) for image data scanned from a document by an image scanning unit (for example, an image scanning unit 911 to be described later) at the time of scanning processing, FAX transmission processing, copying processing, etc. by the MFP 91 to MFP 9n, thereby taking in related information. In addition, the related information take-in unit 101 takes in related information based on utilization history information (input/output history) such as input date and time, input user, paper size, color or monochrome, output destination, transmission destination stored in the database 2.

The locality information take-in unit 102 is provided with a function of taking in locality information (name of management shelf, name of desk, name of room, position information (longitude, latitude, etc.), who takes custody, etc.) concerning the locality of a document whose information is taken in by the related information take-in unit 101. The locality information may be character information or numeric information so long as the place where a document is managed can be specified. As methods of taking in locality information by the locality information take-in unit 102, there is one of, in case of estimating information concerning the locality of a document by the locality information estimation unit 104 to be described later, taking in information concerning thus estimated locality as locality information, and another one of taking in input contents by a user accepted by an operation input unit, not shown, of the PC 3 as locality information.

The correspondence making unit 103 makes related information taken in by the related information take-in unit 101 and locality information taken in by the locality information take-in unit 102 correspond to each other, and makes the database 2 store these information with the related information being a retrieval key such that information concerning the locality of a document can be retrieved from an external device that can communicate with the PC 3, database 2, etc.

The locality information estimation unit 104 is provided with a function of estimating information concerning the locality of a document whose related information is taken in by the related information take-in unit 101 based on the related information taken in by the related information take-in unit 101. The processing of estimating locality information by the locality information estimation unit 104 is carried out based on rule information and related information stored in the database 2 in advance.

The CPU 105 is provided with a function of performing various processing in the document management system, and is also provided with a function of realizing various functions by executing programs stored in the memory 106. The memory 106 may be a ROM, a RAM, etc., and is provided with a function of storing various items of information and programs to be utilized in the document management system.

The database 2 may be an HDD, etc., and is provided with a function of accumulating above-described utilization history information, storing related information to be taken in by the related information take-in unit 101, storing rule information (details of which will be described later), etc. to be utilized by the locality information estimation unit 104.

The PC 3 has an operation input unit, not shown, that accepts operation input by a user, and is provided with a function of transmitting print out command and image scanning command for a desired document to the respective MFP 91 to MFP 9n based on the operation input. The PC 3 retrieves information stored in the database 2 based on operation input by a user, and can display an image of the retrieval result on a display unit, not shown.

The MFP 91 includes an image scanning unit 911 that scans an image of a document, and an image forming unit 912 that forms an image on a sheet. The configuration of the MFP 92 to MFP 9n is similar to that of the MFP 91.

Under above-described configuration, the document management system in this embodiment performs the processing of managing information concerning the locality of documents such that the information can be retrieved based on related information which is related to the documents to be managed.

In this embodiment, the related information take-in unit, locality information take-in unit, correspondence making unit, and locality information estimation unit in the document management system are arranged in the server 1. On the other hand, the present invention is not to restricted to this, and any one or some of the related information take-in unit, locality information take-in unit, correspondence making unit, and locality information estimation unit may be arranged in the MFP, PC, etc., and any configuration can be employed so long as the function of the respective components (the related information take-in unit, locality information take-in unit, correspondence making unit, and locality information estimation unit) is realized in the whole document management system.

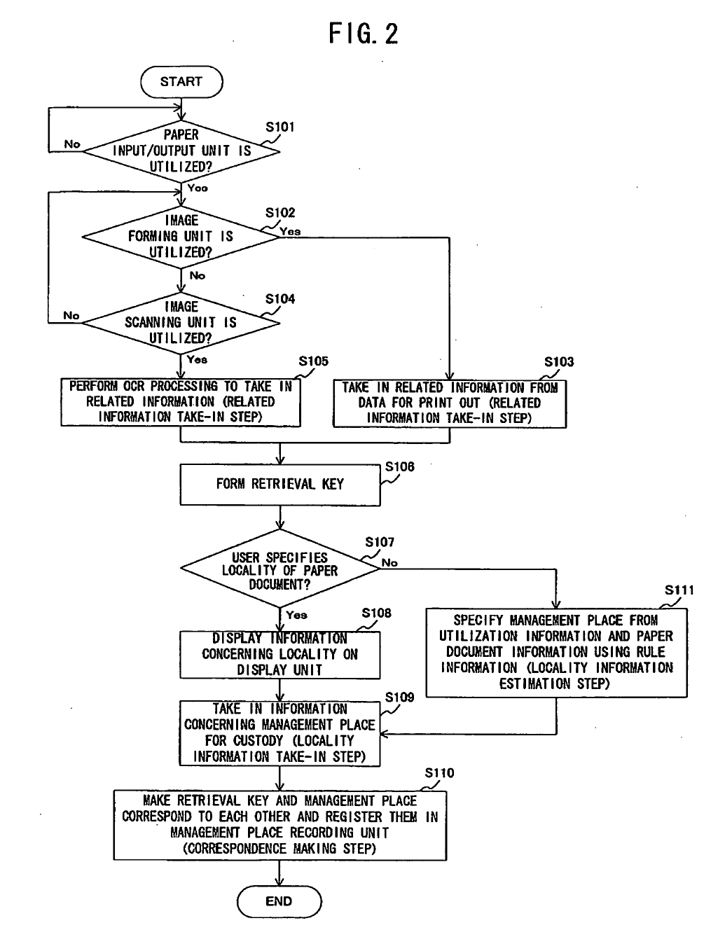

FIG. 2 shows a flow chart for explaining the flow of the processing in the document management system (document management method) in this embodiment.

For example, the image scanning unit 911 or the image forming unit 912 of the MFP-91 is utilized (S101, Yes). In case the image forming unit 912 is utilized (S102. Yes), the related information take-in unit 101 takes in data for print out to be transmitted to the image forming unit 912, and takes in at least part or all of contents information (contents of a text and a diagram, etc.) as document contents, document title, name of document composer, name of document updater, category of document (extension, used application, etc.), size of print sheet from the data for print out as related information (related information take-in step) (S103).

On the other hand, the image forming unit 912 is not utilized (S102, No), and the image scanning unit 911 is utilized (S104, Yes), the related information take-in unit 101 performs predetermined image recognition processing (for example, the OCR processing) for image data scanned from a document by the image scanning unit 911 so as to convert image data to character information and divide the character information into words using the morphological analysis processing, thereby taking in the words as related information (related information take-in step) (S105). The related information taken in by the related information take-in unit 101 is part or all of contents information as contents of a document. In addition, the related information take-in unit 101 is so configured as to take in information concerning the size of a draft, color of the background and characters, and layout of contents of a draft as related information based on the image data.

The related information take-in unit 101 can also take in utilization history information as history information concerning document utilization stored in the database 2 as related information. The utilization history information in this case corresponds to information concerning the name of an image scanning unit or image forming unit (input/output device), installation site of the image scanning unit or image forming unit, utilization date and time of the file (date and time when image scanning or image forming is carried out), utilization method (image scanning?, image forming?, etc.), and operation information concerning paper utilization (for example, number of input papers, number of output papers, etc.).

Next, the related information take-in unit 101 forms a retrieval key for use in retrieving the locality of a document based on thus taken in related information (S106).

Then, in case the user operates the PC 3 to input information concerning the locality of a document whose related information is taken in by the related information take-in step (S107, Yes), an image of the input contents (locality information) is displayed on a display unit, not shown, (S108), and the locality information take-in unit 102 takes in locality information concerning the locality of the document input at the PC 3 (locality information take-in step) (s109).

On the other hand, information concerning the locality of a document is not taken in based on the operation input by the user (S107, No), the locality information estimation unit 104 estimates information concerning the locality of a document whose related information is taken in by the related information take-in step based on the related information taken in by the related information take-in step (locality information estimation step).

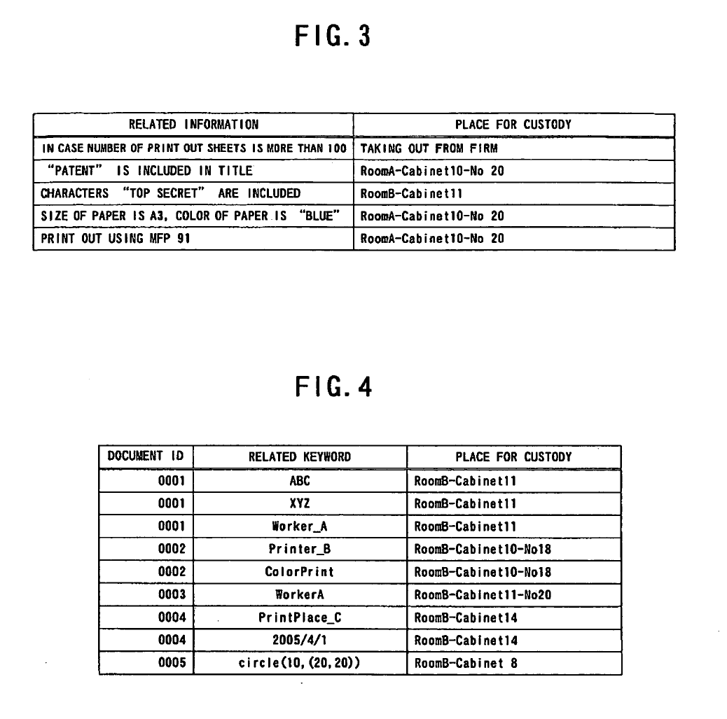

Specifically, the locality information estimation unit 104 estimates information concerning the locality corresponding to the related information taken in by the related information take-in step based on rule information (refer to FIG. 3) in which related information and locality information (place for custody) of a document stored in the database 2 are made to correspond to each other such that in case related information is “size of sheet is A3, color of sheet is blue”, the locality should be “No. 20 of cabinet 10 of Room A”. Contents of the rule information can be arbitrarily set up, being made to correspond to management place of a document.

The locality information take-in unit 102 takes in the locality information input by the user in above-described manner, or the locality information estimated by the locality information estimation unit 104 (locality information take-in step) (S109).

Then, the correspondence making unit 103 makes the related information taken in by the related information take-in step (or formed retrieval key) and the locality information taken in by the locality information take-in step correspond to each other, and registers the related information and locality information in the database 2 such that the locality Information can be retrieved based on the related information (correspondence making step) (S110).

FIG. 4 shows an example of table information registered in the database 2, in which the related information (related keyword) and locality information (place for custody) are made to correspond to each other. In this table, there are shown document ID being the object, related information related to the ID, and locality information, which are made to correspond to each other to be stored. The manner of storing the related information and information concerning the locality of a document is not restricted to this, and there may be employed a storage manner in which related information and locality information alone are made to correspond to each other.

The respective steps in the processing of above-described document management method can be realized by making the CPU 105 execute a document management program stored in the memory 106.

In the embodiment, function of carrying out the present invention is recorded in the device in advance. On the other hand, the present invention is not restricted to this, and similar function may be downloaded to the device through the network, or a recording medium having stored therein similar function may be installed to the device. As a recording medium, any configuration can be employed so long as the recording medium can store therein a program and the program can be read out by the device, that is, a CD-ROM, etc. Function obtained by installing and downloading in advance can be realized in cooperation with an OS (operating system), etc. arranged in the device.

Although shown implemented in a personal computer, the invention may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run any operating system, including, for example, variations of the Linux, Unix, MS-DOS, Microsoft Windows, Palm OS, and Apple Mac OS X operating systems.

Although the techniques discussed herein are described with regard to a compact disk, the techniques may be implemented with any storage media in any storage device included with or otherwise coupled or attached to a computing device. These storage media include, for example, magnetic media such as hard disks, floppy disks and tape: optical media such as compact disks (CD-ROM and CD-RW) and digital versatile disks (DVD and DVD±RW); flash memory cards; and any other storage media. As used herein, a storage device is a device that allows for reading and/or writing to a storage medium. Storage devices include, hard disk drives, DVD drives, flash memory devices, and others.

By data unit, it is meant a frame, cell, datagram, packet or other unit of information.

While the invention has been described in accordance with certain preferred embodiments thereof and described in the above description in detail, it should be understood by those ordinarily skilled in the art that the invention is not limited to the embodiments, but various modifications, alternative constructions or equivalents can be implemented without departing from the scope and spirit of the present invention.

As has been described in the above, according to the present invention, it becomes possible to provide a technique that can retrieve the locality of documents based on a retrieval key even though electronic data of the documents to be managed do not exist, or some items of information (tag, bar-code, etc.) are not appended to the documents themselves.

It is claimed:

1. A document management system that manages information concerning the locality of documents such that the information can be retrieved based on related information which is related to the documents to be managed, comprising:
a related information take-in unit that takes in the related information;
a locality information take-in unit that takes in locality information concerning the locality of a document whose information is taken in by the related information take-in unit; and
a correspondence making unit that makes related information taken in by the related information take-in unit and locality information taken in by the locality information take-in unit correspond to each other.

2. The document management system according to claim 1, further comprising a locality information estimation unit that estimates information concerning the locality of a document whose related information is taken in by the related information take-in unit based on the related information taken in by the related information take-in unit,
wherein the locality information take-in unit takes in information concerning the locality of a document which is estimated by the locality information estimation unit as the locality information.

3. The document management system according to claim 1,
wherein the related information take-in unit takes in the related information based on data for print out that is transmitted to an image forming unit which forms an image on a sheet so as to perform print out processing.

4. The document management system according to claim 3.
wherein the related information is at least part or all of contents information which is contents of a document, document title, document composer, document updater, and document category.

5. The document management system according to claim 1.
wherein the related information take-in unit takes in utilization history information as history information concerning document utilization.

6. The document management system according to claim 1,
wherein the related information take-in unit takes in the related information by performing predetermined image recognition processing for image data scanned from the document.

7. A document management method that manages information concerning the locality of documents such that the information can be retrieved based on related information which is related to the documents to be managed, comprising:
a related information take-in step that takes in the related information;
a locality information take-in step that takes in locality information concerning the locality of a document whose information is taken in by the related information take-in step; and
a correspondence making step that makes related information taken in by the related information take-in step and locality information taken in by the locality information take-in step correspond to each other.

8. The document management method according to claim 7, further comprising a locality information estimation step that estimates information concerning the locality of a document whose related information is taken in by the related information take-in step based on the related information taken in by the related information take-in step,
wherein the locality information take-in step takes in information concerning the locality of a document which is estimated by the locality information estimation step as the locality information.

9. The document management method according to claim 7,
wherein the related information take-in step takes in the related information based on data for print out that is transmitted to an image forming unit which forms an image on a sheet so as to perform print out processing.

10. The document management method according to claim 9,
wherein the related information is at least part or all of contents information which is contents of a document, document title, document composer, document updater, and document category.

11. The document management method according to claim 7,
wherein the related information take-in step takes in utilization history information as history information concerning document utilization.

12. The document management method according to claim 7,
wherein the related information take-in step takes in the related information by performing predetermined image recognition processing for image data scanned from the document.

13. A document management program that makes a computer execute the processing of managing information concerning the locality of documents such that the information can be retrieved based on related information which is related to the documents to be managed, the program making a computer to execute:
a related information take-in step that takes in the related information;
a locality information take-in step that takes in locality information concerning the locality of a document whose information is taken in by the related information take-in step; and
a correspondence making step that makes related information taken in by the related information take-In stop and locality information taken in by the locality information take-in step correspond to each other.

14. The document management program according to claim 13, the program further comprising a locality information estimation step that estimates information concerning the locality of a document whose related information is taken in by the related information take-in step based on the related information taken in by the related information take-in step,
wherein the locality information take-in step takes in information concerning the locality of a document which is estimated by the locality information estimation step as the locality information.

15. The document management program according to claim 13,
wherein the related information take-in step takes in the related information based on data for print out that is transmitted to an image forming unit which forms an image on a sheet so as to perform print out processing.

16. The document management program according to claim 15,
wherein the related information is at least part or all of contents information which is contents of a document, document title, document composer, document updater, and document category.

17. The document management program according to claim 13,
wherein the related information take-in step takes in utilization history information as history information concerning document utilization.

18. The document management program according to claim 13,
wherein the related information take-in step takes in the related information by performing predetermined image recognition processing for image data scanned from the document.

19. The document management program according to claim 18,
wherein the predetermined image recognition processing is the OCR processing.

20. The document management program according to claim 18,
wherein the related information is part or all of contents information which is contents of the document.
